(19) United States
(12) Patent Application Publication
(10) Pub. No.: US 2015/0346818 A1
(43) Pub. Date: Dec. 3, 2015

(54) SYSTEM AND METHOD FOR DETECTING MICRO EYE MOVEMENTS IN A TWO DIMENSIONAL IMAGE CAPTURED WITH A MOBILE DEVICE

(71) Applicant: UMOOVE SERVICES LTD., Jerusalem (IL)

(72) Inventors: Yitzchak KEMPINSKI, Geva Binyamin (IL); Arkady GORODISCHER, Jerusalem (IL); Sophia FRIJ, Maale Adumim (IL); Jonathan GUEZ, Jerusalem (IL)

(21) Appl. No.: 14/722,317

(22) Filed: May 27, 2015

Related U.S. Application Data
(60) Provisional application No. 62/003,066, filed on May 27, 2014.

(51) Int. Cl. G06F 3/01; G06K 9/00

(52) U.S. Cl. CPC G06F 3/013; G06K 9/00604

(57) ABSTRACT

A system and method for using a mobile device to capture an image of eyes of a person and calculate a location or coordinates of one or each of the irises in a first frame and a location or coordinate of the same iris in a later frame. A vector may be calculated between the location or coordinate of a first iris in a first frame and a location or coordinate of the first iris in a second frame. A second eye vector may be calculated between the location or coordinate of a second iris in a first frame and such second iris in a second frame. An angle between the first iris vector and the second iris vector may be calculated. Such angle may be used as an indication of a physiological problem.

### CROSS-REFERENCE TO RELATED APPLICATIONS

This application claims priority of U.S. Provisional Patent Application No. 62/003,066, filed May 27, 2014, which is hereby incorporated by reference.

Among the challenges of tracking and detecting tiny eye movements using a camera or imager that captures two dimensional images using visible light, such as a camera that may be included in a mobile electronic device, are the following: frame image noise, low and varying frame capture rates, instability or movements of the camera or imaging device, movement of the subject's eyes or head, poor or varying light conditions, etc.

Detected eye movements in a series of images may not represent actual eye movements, and may be noise or inaccurate detections. Such noise may complicate or degrade the results or significance of detected eye movements.

Eye movements may follow one or more of several patterns including the following:
Saccades—rapid, ballistic movements of the eyes that abruptly change the point of gaze.
Smooth pursuit—the eyes move smoothly following an object.
Micro Saccades—small, fast jerk-like movements in which the eye remains relatively still.
Fixation—the eyes maintain a visual gaze on a single location.

### EMBODIMENTS OF THE INVENTION

To better understand embodiments of the invention and appreciate its practical applications, the following figures are provided and referenced hereafter. It should be noted that the figures are given as examples only and in no way limit the scope of the invention. Like components are denoted by like reference numerals.

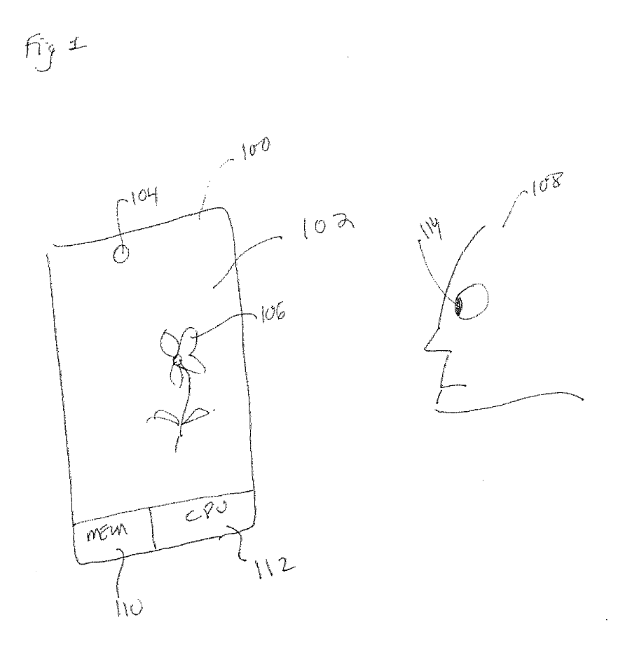

FIG. 1 is a schematic diagram of a system in accordance with an embodiment of the invention;

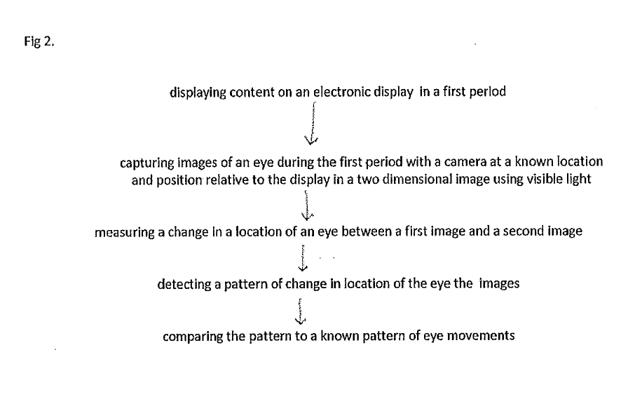

FIG. 2 is a flow diagram in accordance with an embodiment of the invention; and

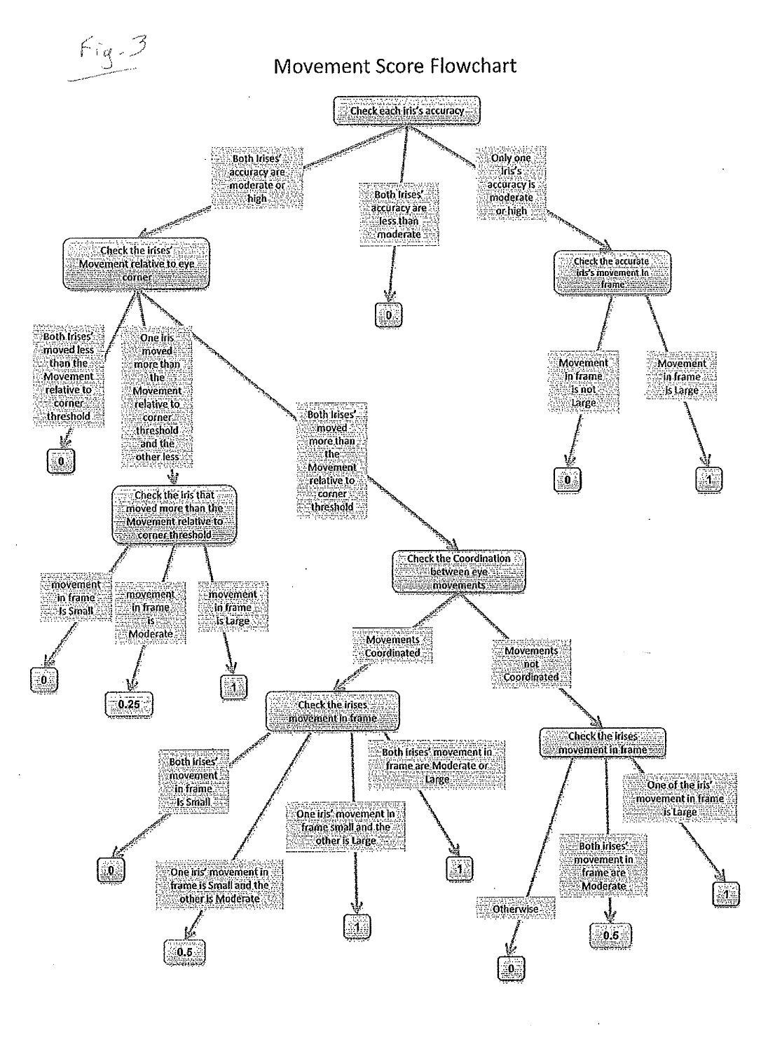

FIG. 3 is a flow diagram of a scoring process in accordance with an embodiment of the invention.

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a non-transitory computer or processor readable medium, or a computer or processor storage medium, such as for example a memory, a disk drive, or a USB flash memory or other non-volatile memory, encoding, including or storing instructions, e.g., computer-executable instructions, which when executed by a processor or controller, carry out methods disclosed herein.

When used in this document, a viewer may, in addition to its regular meaning, refer to a person or animal that is looking at or that is situated in a position to look at a display, screen, object, or object shown on a screen.

When used in this document, and in addition to its regular meaning, an eye may include an iris or pupil and may mean or include an area of one or more eyes of a viewer that includes an area of a pupil and iris or such portion of the pupil as may be covered or uncovered in the dilation and constricting of the iris. In some embodiments a differentiation between the iris and the pupil may not be required such that an entire area encompassed by the iris may be included. A capture of an image of an eye may also include a capture of an image of an eye corner, bridge or tip of a nose, or other feature in an area of an eye(s).

Reference is made to FIG. 1, a diagram of a system in accordance with an embodiment of the invention. System 100 may include an electronic display screen 102 and a camera 104, imager or image capture sensor. Camera 104 may be at a known distance, location, orientation and angle to screen 102, and from a content 106 displayed on screen 102. Screen 102 may display content 106 such as for example text, images or graphics or other items which may be viewed by a user 108 or viewer. Such content 106 may be still or video and may move or be moved on screen 102. System 100 may be associated with one or more mass data storage memory 110 units and a processor 112. In some embodiments, camera 104 may be or include an imaging device suitable to capture two-dimensional still or video images using visible light. Camera 104 and screen 102 may be included in a mobile device such as a cellular telephone, tablet computer, laptop computer or other mobile device. Camera 104 and screen 102 may be associated with a fixed or non-portable device such as a workstation or desktop computer. Other configurations are possible.

Patterns of eye movements may be detected in or between two or a series of frames, and such patterns may be classified as one or more of saccades, smooth pursuit, micro- saccades and fixation, or other patterns. A time or period of time of a detection of a pattern of an eye movement by a user may be recorded, and correlated with a time of an appearance on a screen 102 viewed by the user 108 of an object or content 106. A state of mind, level of interest, level of attention, period of attention or other characteristics of a user's interest in the content object that appeared on the screen 102 may be determined, calculated, implied, estimated or assumed from an eye-movement pattern detected at a time the object 106 appeared on screen 102.

Estimating, calculating or determining a location or coordinates of an eye in one or more frames or captured images may include or be accompanied by an estimate or calculation of a level of confidence or accuracy level of the determined location of the eye in such frames or images. For example a position, location of a calculated coordinate of an iris 114 in a frame may be marked or associated with a an accuracy value such as −1: Bad, unreliable or probably inaccurate result; 1: undetermined accuracy probability; 2: moderate accuracy probability; 3: high accuracy probability.

A movement of an iris 114 in or between frames may be determined or calculated. A movement of an iris may refer to a movement of an eye or iris between a first, prior or previous frame and a second, subsequent or later frame. Such movement of change in position may be calculated for one or both of an X axis and a Y axis. For example, if a location of an iris in frame A is (100,55) and in frame B is (108,57) then the iris movement of frame A-B will be: on the X axis: abs(108−100)=8, and on the Y axis: abs(57−55)=2. Such movements may be categorized into three or more predefined levels:
a. Small Movement in/between Frames—bellow which the movement is assumed to be noise
b. Moderate Movement in/between Frames—movement may be noise or actual eye movement
c. Large Movement in/between Frames—movement is assumed to be actual eye movement Other categorizations or number of categorizations may be user.

A movement of an eye or iris relative to an eye corner, bridge of nose, tip of nose or other body part at a known orientation to an eye or iris may be calculated. The eye movement relative to the eye corner may be calculated for one or both of an X and Y axis. For example, if in frame A, iris location is (100,60) and corner location is (123,52) and in frame B iris location is (105,57) and corner location is (120,53), then the Iris Eye/Corner Movement of Frame A-B will be: X=abs(100−123)−abs(105−120)=8 , Y=abs(60−52)−abs(57−53)=4. Thresholds or categories of Iris Eye/Corner Movement may also be categorized, such that movements distances below a certain threshold may be assumed, weakly assumed or strongly assumed to be noise, and movements above one or more thresholds may be assumed, weakly assumed or strongly assumed to be or indicate actual movement.

The irises of a viewer may usually move together or in coordination. Analyzing or comparing detected movements of a person's two irises may verify whether the detected movement is an actual movement or noise. Iris movement coordination may be examined by calculating each iris's motion vector. Two or more images of one or more eyes, irises and/or areas around an eye may be captured by camera 104. A location or coordinates (such as pixel coordinates) of one or both eyes or irises in each of the frames may be determined. A comparison may be made between a location or coordinates of one or each of the irises in a first, previous or prior frame and a location or coordinate of the same iris in a second, subsequent or later frame. A first eye vector may be calculated between the location or coordinate of a first iris in a first frame and a location or coordinate of the first iris in a second frame. A second eye vector may be calculated between the location or coordinate of a second iris in a first frame and such second iris in a second frame. An angle may be calculated between the first iris vector and the second iris vector. Using the assumption that irises move together or in coordination, a small angle such as below 90° |(though other thresholds may be used) between the first iris vector and the second iris vector may be an indication that the two eyes moved together or in coordination. If the angle is large, it may be an indication that the eyes did not move together or in coordination, and that there is either a physiological problem with the viewer or that there is noise in the detection.

Detected movements of eyes or irises between two or more frames may be accompanied by or associated with a probability of the accuracy or significance of such detected movement. A flow chart of a method of scoring such accuracy or probability of movements is set forth on FIG. 3.

Detected eye movements in space from a series of images may be analyzed and compared to known patterns of eye movements. Noise movements may be eliminated or have their significance reduced.

Detected movements of eyes in two or more frames may be determined, subjected to a ranking for confidence of actual or significant movements as opposed to noise, and categorized or classified into known or recognized patterns of eye movements.

Fixation. For example if there was no (or close to no) visible or significant movement for a period of time, for example 100 milliseconds or more, we may assume the user is in a fixation eye movement pattern. According to the frame rate we may define a fixation frame threshold, for example in 30 Frames Per Second, wherein there are 33.33 milliseconds between frames. If a fixation is detected for a threshold of at least three frames in which the viewer's eyes did not move (or did not move significantly), we may assume that the user is in a fixation eye movement pattern.

Smooth pursuit—If the score as determined in accordance with FIG. 3 is not zero, or is otherwise indicative of an eye movement pattern, the eye locations may be examined further for smooth pursuit movementm looking for the following patterns or characteristics:
a. Speed of movement between frames is less than a predetermined threshold for example if the user's eye moved less than 0.2 cm since the last frame (where 0.2 cm is the predetermined threshold for the current fps), then the type of movement may be smooth pursuit.
b. There is a small angle between the current eye movement vector and a previous eye movement vector.
c. Current and previous eye movement vectors create a relatively smooth pattern of changes in speed and acceleration.

Micro Saccades—If there is assumed to be real eye movement rather than noise or other immaterial movement, and real space movement is less than a small predefined threshold (such as less than 2 degrees), we may assume the movement was a micro-saccade.

Saccades—If there is assumed to be real movement and in real space movement such movement is larger than a predefined threshold, we may assume the movement was a saccade.

In some embodiments, eye movements between two or some other small number of frames may be determined or collected. A further, additional or alternative analysis may be made of a sequence of frames that occurred in a period of time. An estimate may be made of the activity in the specified time period summing up the amount of saccadic movements, fixations and smooth pursuit that occurred. A conversion may be made of the movements into percentages of the time period under analysis (for example one second) taking into account the current FPS. The result may be the basis of analyzing the user's state of mind during that period of time. For example a high amount of saccadic activity with repeated fixations/smooth pursuits throughout the time period may indicate a higher level of engagement and interest.

Other indications and detected eye movements as presented in pathologies may include the following:

Anti-Saccades: Frequent lapses in attention area characteristic of Traumatic Brain Injury (TBI) Anti Saccades tasks, a type of eye movement paradigm sensitive to frontal lobe dysfunction that may rely on discrete stimulus-response sets. Anti Saccades tasks may be useful in detecting Post Concussion Syndrome (PCS).

Visual Tracking: Visual Tracking performance may provide a continuous behavioral assessment metric and is highly predictable, and often compromised in mild traumatic brain injury.

Visual Scanning: Abnormal facial scanning indicated in Autism.

Smooth Pursuit: Abnormal Smooth Pursuit Eye Movement is an observed neurophysiologic deficit in schizophrenia patients, and Parkinson's disease.

Saccadic eye movement abnormalities: Decline in prosaccade latency and velocity seen in Huntigntons disease, and microsaccades.

Visual Paired Comparison: Saccade orientation, re-fixations and fixation duration, saccade dysfunction seen in cognitive decline such as Alzheimer's disease.

Vertical Saccades: Hypometria type abnormality for vertical saccades seen in Parkinson's disease.

Slowing Saccades: Decreased smooth pursuit, Decreased velocity: Pharma affects of Benzodiazepenes, antipyshicotics.

Increase in peak velocity of Prosaccades: Pharma affect of Antidepressents Shortened latency seen in Nicotine

1. A method of determining an interest of a user in a displayed content, comprising:
displaying in first period said content on an electronic display;
capturing during said first period a plurality of images of an eye of said user, said capturing with a camera at a known location and position relative to said display, said capturing in a two dimensional image using visible light;
measuring a change in a location of said eye between a first of said plurality of images and a second of said plurality of images;
detecting a pattern of said changes in location in said plurality of images; and
comparing said pattern to a known patter of eye movements.

2. The method as in claim 1, comprising associating said pattern of eye movements with said content.

3. A system for determining an interest of a user in a displayed content, the system comprising:
an electronic display to display a content item during a first time period;
an image capture device at a known distance and orientation from said content item displayed on said electronic display, said image capture device configured to capture during said time period a plurality of images of an eye of a viewer of said content item in a two dimensional image using visible light,
a memory; and
a processor, said processor to
issue a signal to display said content item on said electronic display during said time period;
measure a change in a location of said eye between a first of said plurality of images and a second of said plurality of images; and
detect a pattern of said changes in location in said plurality of images.

4. The system as in claim 3, wherein said processor is to compare said pattern to a known patter of eye movements.

5. The system as in claim 3, wherein said processor is to use said detected pattern to calculate an interest of said user in said content item.

6. The system as in claim 5, wherein said memory is to store an association of said user with said content item and said calculated interest.

7. The system as in claim 3, wherein said processor is configured to calculate a confidence level of said change in said location of said eye.

8. The system as in claim 3, wherein said processor is configured to correlate a detected change in said location of a first eye in said plurality of frames to a change in a location of a second eye in said plurality of frames.
